(19) United States
(12) Patent Application Publication
(10) Pub. No.: US 2025/0132085 A1
(43) Pub. Date: Apr. 24, 2025

(54) COIL COMPONENT

(71) Applicant: SAMSUNG ELECTRO-MECHANICS CO., LTD., Suwon-si (KR)

(72) Inventors: Tae Hyun KIM, Suwon-si (KR); Byeong Cheol MOON, Suwon-si (KR)

(73) Assignee: SAMSUNG ELECTRO-MECHANICS CO., LTD., Suwon-si (KR)

(21) Appl. No.: 18/885,451

(22) Filed: Sep. 13, 2024

(30) Foreign Application Priority Data
Oct. 19, 2023 (KR) 10-2023-0140075

(51) Int. Cl. H01F 27/29; H01F 27/255; H01F 27/30; H01F 27/32

(52) U.S. Cl. CPC H01F 27/292; H01F 27/255; H01F 27/306; H01F 27/323

(57) ABSTRACT

A coil component includes: a body having a first surface and a second surface opposing each other in a first direction, and a third surface and a fourth surface opposing each other in a second direction perpendicular to the first direction; a support member disposed inside the body and having one surface and another surface opposing each other, and a side surface connecting the one surface and the other surface to each other; a coil disposed on the support member 10 and including coil portions respectively having at least one turn and lead portions extending from respective outermost turns of the coil portions and bent toward the first surface; and external electrodes disposed on the first surface and connected to the respective lead portions.

### CROSS-REFERENCE TO RELATED APPLICATION(S)

This application claims the benefit of priority to Korean Patent Application No. 10-2023-0140075 filed on Oct. 19, 2023 in the Korean Intellectual Property Office, the disclosure of which is incorporated herein by reference in its entirety.

### TECHNICAL FIELD

The present disclosure relates to a coil component.

### BACKGROUND

An inductor, a coil component, is a representative passive electronic component used in an electronic device together with a resistor and a capacitor.

As electronic devices are increasingly high-performance and miniaturized, the number of electronic components used in electronic devices is increasing, and the electronic components are becoming smaller.

Meanwhile, when external electrodes are disposed only on a lower surface of a coil component, the risk of short circuit with adjacent components is lowered when mounted on a circuit board, which is advantageous for integration. There is a demand for a coil component that may secure an effective volume while having such a lower electrode structure.

### SUMMARY

An aspect of the present disclosure is to provide a coil component in which external electrodes are disposed only on a lower surface, increasing an effective volume as compared to a coil component of the same size and thereby improving an inductance characteristics.

Another aspect of the present disclosure is to improve plating quality and insulation reliability of a lead portion by implementing a coil covered with an insulating film and led out from a lower surface of a body and then forming the body.

According to an aspect of the present disclosure, a coil component includes: a body having a first surface and a second surface opposing each other in a first direction, and a third surface and a fourth surface opposing each other in a second direction perpendicular to the first direction; a support member disposed inside the body and having one surface and another surface opposing each other, and a side surface connecting the one surface and the other surface to each other; a coil disposed on the support member and including coil portions respectively having at least one turn and lead portions extending from respective outermost turns of the coil portions and bent toward the first surface; and external electrodes disposed on the first surface and connected to the respective lead portions.

According to another aspect of the present disclosure, a coil component includes: a body; a support member embedded in the body; a coil including a first coil portion disposed on one surface of the support member and a second coil portion disposed on another surface of the support member opposing the one surface; first and second lead portions extending toward a same side surface of the body from respective outermost turns of the first and second coil portions; and first and second external electrodes disposed on the body and connected to the first and second lead portions, respectively, in which the first and second lead portions have first and second bent portions in the body and further extend to be connected to the first and second external electrodes, respectively.

### BRIEF DESCRIPTION OF DRAWINGS

The above and other aspects, features, and advantages of the present disclosure will be more clearly understood from the following detailed description, taken in conjunction with the accompanying drawings, in which:

FIG. 1 is a schematic perspective view illustrating a coil component according to a first exemplary embodiment in the present disclosure;

FIG. 2 is an exploded perspective view of FIG. 1;

FIG. 3 is a cross-sectional view taken along line I-I′ of FIG. 1;

FIG. 4 is a cross-sectional view taken along line II-II′ of FIG. 1;

FIG. 5 is a cross-sectional view taken along line III-III′ of FIG. 1;

FIG. 6 is a cross-sectional view taken along line IV-IV′ of FIG. 1;

FIG. 7 is a schematic perspective view illustrating a coil component according to a second exemplary embodiment in the present disclosure;

FIG. 8 is a cross-sectional view taken along line V-V′ of FIG. 7;

FIG. 9 is a schematic view illustrating a coil bar state before a plurality of coils are individualized;

FIG. 10 is a schematic view illustrating a process of bending the lead portion downward;

FIG. 11 is a schematic view illustrating a process of forming the body using a mold; and

FIG. 12 is a schematic view illustrating a process of forming the body by stacking magnetic sheets.

### DETAILED DESCRIPTION

Terms used in the present specification are used only in order to describe specific exemplary embodiments rather than limiting the present disclosure. Singular forms are intended to include plural forms unless the context clearly indicates otherwise. It is to be understood that the terms “include” or “have” used here specify the presence of features, numbers, steps, operations, components, parts, or combinations thereof mentioned in the present specification, or combinations thereof, but do not preclude the presence or addition of one or more other features, numbers, steps, operations, components, parts, or combinations thereof. In addition, throughout the specification, “on” does not necessarily mean that any element is positioned on an upper side based on a gravity direction, but means that any element is positioned above or below a target portion.

Further, a term “couple” not only refers to a case where respective components are in physically direct contact with each other, but also refers to a case where the respective components are in contact with another component with another component interposed therebetween, in a contact relationship between the respective components.

Since sizes and thicknesses of the respective components illustrated in the drawings are arbitrarily illustrated for convenience of explanation, the present disclosure is not necessarily limited to those illustrated in the drawings.

In the drawings, a T direction refers to a first direction or a thickness direction, a W direction refers to a second direction or a width direction, and an L direction refers to a third direction or a length direction.

Hereinafter, coil components according to exemplary embodiments in the present disclosure will be described in detail with reference to the accompanying drawings. In describing exemplary embodiments in the present disclosure with reference to the accompanying drawings, components that are the same as or correspond to each other will be denoted by the same reference numerals, and an overlapping description thereof will be omitted.

Various kinds of electronic components may be used in electronic devices, and various kinds of coil components may be appropriately used between these electronic components depending on their purposes in order to remove noise, or the like.

That is, the coil components used in the electronic devices may be a power inductor, high frequency (HF) inductors, a general bead, a bead for a high frequency (GHz), a common mode filter, and the like.

### First Exemplary Embodiment

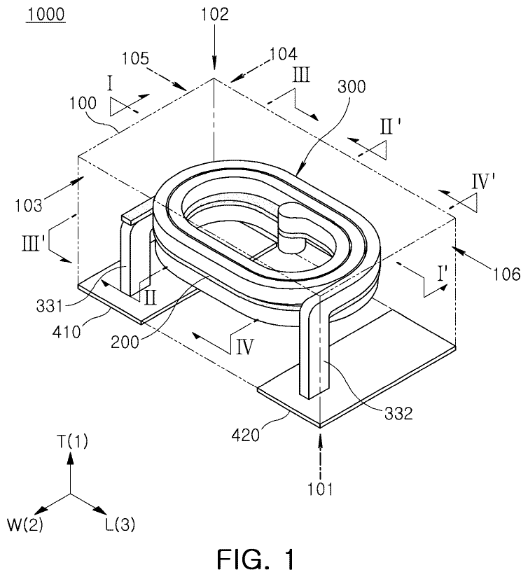

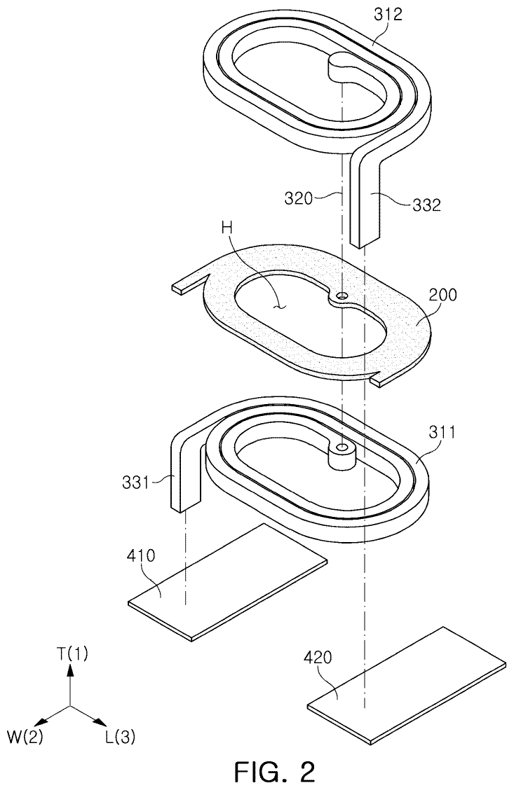

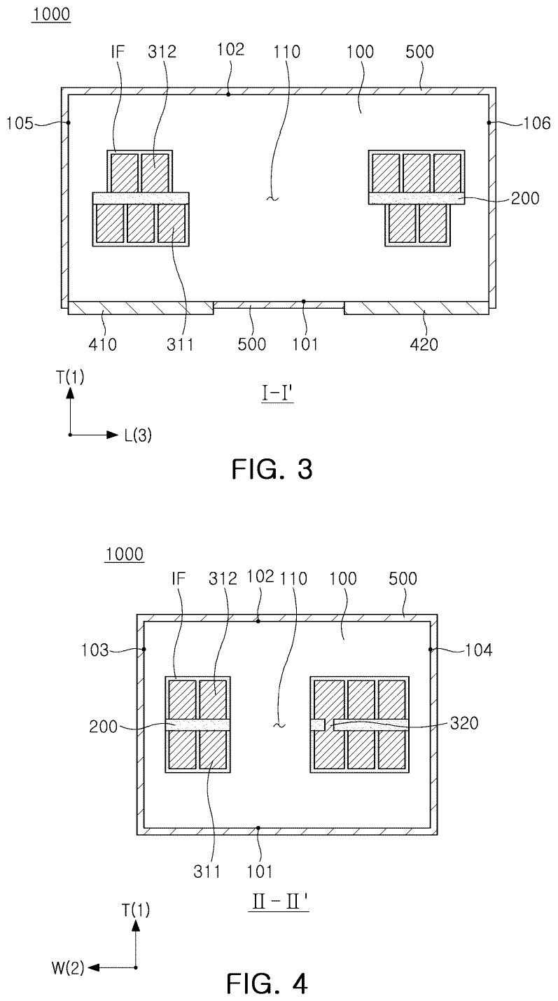

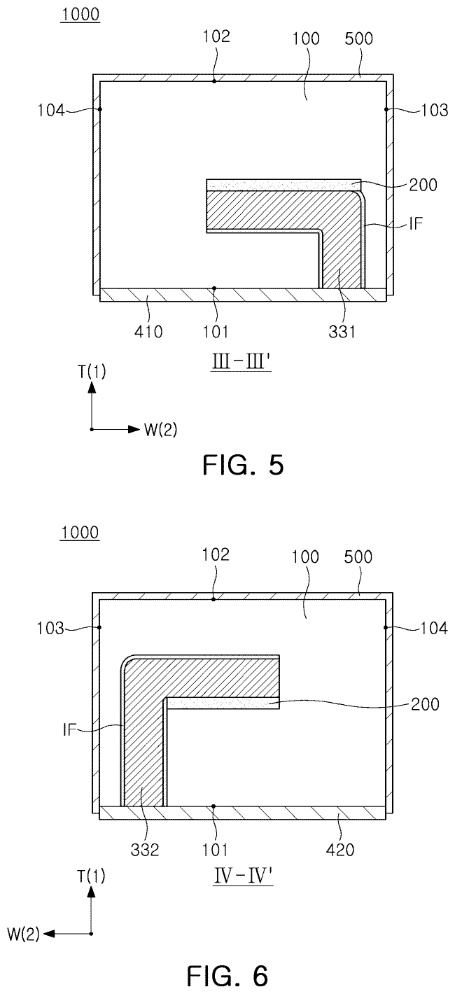

FIG. 1 is a schematic perspective view illustrating a coil component 1000 according to a first exemplary embodiment in the present disclosure. FIG. 2 is an exploded perspective view of FIG. 1. FIG. 3 is a cross-sectional view taken along line I-I′ of FIG. 1. FIG. 4 is a cross-sectional view taken along line II-II′ of FIG. 1. FIG. 5 is a cross-sectional view taken along line III-III′ of FIG. 1. FIG. 6 is a cross-sectional view taken along line IV-IV′ of FIG. 1.

In FIGS. 1 and 2, an insulating film IF on a coil 300 and an insulating layer 500 on a body 100 that may be applied to the present exemplary embodiment are omitted to more clearly illustrate coupling between components.

Referring to FIGS. 1 through 6, the coil component 1000 according to the first exemplary embodiment in the present disclosure may include the body 100, a support member 200, the coil 300, and external electrodes 410 and 420.

In the coil component 1000 according to the present exemplary embodiment, the coil 300 may be disposed on the support member 200 by plating, and in particular, lead portions 331 and 332 included in the coil 300 may be bent toward a first surface 101 of the body 100, so that the external electrodes 410 and 420 disposed on the first surface 101 corresponding to a mounting surface may be connected to the lead portions 331 and 332, respectively.

In the present exemplary embodiment, a lower electrode structure may be easily implemented without a separate process such as via hole formation in a lower surface of the body 100 or recess formation for exposing the lead portions 331 and 332, and an effective volume occupied by magnetic materials in the body 100 may be secured, thereby improving an inductance characteristic.

Further, the insulating film IF may be disposed also in a region where the lead portions 331 and 332 are bent downward, and thus, insulation reliability between the lead portions 331 and 332 and the body 100 may be enhanced.

In addition, the lead portions 331 and 332 may extend and then bent downward in a coil bar state in which a plurality of coils 300 are connected in a lattice form. Therefore, plating quality of the lead portions 331 and 332 may also be improved as compared to a process in which the lead portions 331 and 332 are formed by plating after forming via holes in the lower surface of the body 100.

Hereinafter, the main components of the coil component 1000 according to the present exemplary embodiment will be described in detail.

The body 100 may form an appearance of the coil component 1000 according to the present exemplary embodiment, and may embed the support member 200 and the coil 300 therein.

The body 100 may generally have a hexahedral shape.

The body 100 may have a first surface 101 and a second surface 102 opposing each other in the thickness direction T (first direction), a third surface 103 and a fourth surface 104 opposing each other in the width direction W (second direction), and a fifth surface 105 and a sixth surface 106 opposing each other in the length direction L (third direction) in FIG. 1. Each of the third to sixth surfaces 103 to 106 of the body 100 may correspond to a wall surface of the body 100 connecting the first and second surfaces 101 and 102 of the body 100 to each other.

As an example, the body 100 may be formed in such a way that the coil component 1000 according to the present exemplary embodiment including the external electrodes 410 and 420 has a length of 2.5 mm, a width of 2.0 mm, and a thickness of 0.8 mm, a length of 2.0 mm, a width of 1.2 mm, and a thickness of 0.6 mm, a length of 1.6 mm, a width of 0.8 mm, and a thickness of 0.6 mm, a length of 1.6 mm, a width of 0.8 mm, and a thickness of 0.4 mm, a length of 1.4 mm, a width of 1.2 mm, and a thickness of 0.65 mm, a length of 1.0 mm, a width of 0.7 mm, and a thickness of 0.65 mm, a length of 0.8 mm, a width of 0.4 mm, and a thickness of 0.65 mm, or a length of 0.8 mm, a width of 0.4 mm, and a thickness of 0.5 mm, but is not limited thereto.

Meanwhile, since the above-described exemplary numerical values of the length, width, and thickness of the coil component 1000 refer to numerical values that do not reflect process errors, it should be considered that numerical values in an allowable process error range correspond to the above-described exemplary numerical values.

The length of the coil component 1000 described above may refer to the largest value among dimensions of a plurality 41 segments that connect two outermost boundary lines of the coil component 1000 facing each other in the length direction L in a direction parallel to the length direction L and are spaced apart from each other in the thickness direction T, in an image of a cross section of a central portion of the coil component 1000 in the width direction W, the image being taken by an optical microscope or a scanning electron microscope (SEM), and the cross section being taken along the length direction L and the thickness direction T. Alternatively, the length of the coil component 1000 may refer to the smallest value among the dimensions of the plurality of line segments described above. Alternatively, the length of the coil component 1000 may refer to an arithmetic mean of at least three of the dimensions of the plurality of line segments described above. Here, the plurality of line segments parallel to the length direction L may be equally spaced apart from each other in the thickness direction T, but the scope of the present disclosure is not limited thereto.

The thickness of the coil component 1000 described above may refer to the largest value among dimensions of a plurality of line segments that connect two outermost boundary lines of the coil component 1000 facing each other in the thickness direction T in a direction parallel to the thickness direction T and are spaced apart from each other in the length direction L, in an image of the cross section of the central portion of the coil component 1000 in the width direction W, the image being taken by an optical microscope or a scanning electron microscope (SEM), and the cross section being taken along the length direction L and the thickness direction T. Alternatively, the thickness of the coil component 1000 may refer to the smallest value among the dimensions of the plurality of line segments described above. Alternatively, the thickness of the coil component 1000 may refer to an arithmetic mean of at least three of the dimensions of the plurality of line segments described above. Here, the plurality of line segments parallel to the thickness direction T may be equally spaced apart from each other in the length direction L, but the scope of the present disclosure is not limited thereto.

The width of the coil component 1000 described above may refer to the largest value among dimensions of a plurality of line segments that connect two outermost boundary lines of the coil component 1000 facing each other in the width direction W in a direction parallel to the width direction W and are spaced apart from each other in the length direction L, in an image of a cross section of the central portion of the coil component 1000 in the thickness direction T, the image being taken by an optical microscope or a scanning electron microscope (SEM), and the cross section being taken along the length direction L and the width direction W. Alternatively, the width of the coil component 1000 may refer to the smallest value among the dimensions of the plurality of line segments described above. Alternatively, the width of the coil component 1000 may refer to an arithmetic mean of at least three of the dimensions of the plurality of line segments described above. Here, the plurality of line segments parallel to the width direction W may be equally spaced apart from each other in the length direction L, but the scope of the present disclosure is not limited thereto.

Alternatively, each of the length, the width, and the thickness of the coil component 1000 may be measured by a micrometer measurement method. According to the micrometer measurement method, measurement may be performed by zeroing a micrometer subjected gage repeatability and reproducibility (R&R), inserting the coil component 1000 according to the present exemplary embodiment between tips of the micrometer, and turning a measurement lever of the micrometer. Meanwhile, when measuring the length of the coil component 1000 by the micrometer measurement method, the length of the coil component 1000 may refer to a value obtained by performing the measurement once, or an arithmetic mean of values obtained by performing the measurement multiple times. The same may apply to the width and the thickness of the coil component 1000.

The body 100 may include magnetic materials and a resin. Specifically, the body 100 may be formed by stacking one or more magnetic composite sheets in which the magnetic material is dispersed in the resin. However, the body 100 may also have a structure other than a structure in which the magnetic materials are dispersed in the resin. For example, the body 100 may include a magnetic material such as ferrite or may include a non-magnetic material.

The magnetic material may be ferrite or magnetic metal powder.

The ferrite may be, for example, at least one of spinel type ferrite such as Mg—Zn-based ferrite, Mn—Zn-based ferrite, Mn—Mg-based ferrite, Cu—Zn-based ferrite, Mg—Mn—Sr-based ferrite, or Ni—Zn-based ferrite, hexagonal ferrite such as Ba—Zn-based ferrite, Ba—Mg-based ferrite, Ba—Ni-based ferrite, Ba—Co-based ferrite, or Ba—Ni—Co-based ferrite, garnet type ferrite such as Y-based ferrite, or Li-based ferrite.

The magnetic metal powder may include one or more selected from the group consisting of iron (Fe), silicon (Si), chromium (Cr), cobalt (Co), molybdenum (Mo), aluminum (Al), niobium (Nb), copper (Cu), and nickel (Ni). For example, the magnetic metal powder may be at least one of pure iron powder, Fe—Si-based alloy powder, Fe—Si—Al-based alloy powder, Fe—Ni-based alloy powder, Fe—Ni—Mo-based alloy powder, Fe—Ni—Mo—Cu-based alloy powder, Fe—Co-based alloy powder, Fe—Ni—Co-based alloy powder, Fe—Cr-based alloy powder, Fe—Cr—Si-based alloy powder, Fe—Si—Cu—Nb-based alloy powder, Fe—Ni—Cr-based alloy powder, or Fe—Cr—Al-based alloy powder.

The magnetic metal powder may be amorphous or crystalline. For example, the magnetic metal powder may be Fe—Si—B—Cr based amorphous alloy powder, but is not necessarily limited thereto.

The ferrite and the magnetic metal powder may each have an average diameter of about 0.1 μm to 30 μm, but are not limited thereto.

The body 100 may include two kinds or more of magnetic materials dispersed in the resin. Here, different kinds of magnetic materials mean that the magnetic materials dispersed in the resin are distinguished from each other by any one of an average diameter, a composition, crystallinity, and a shape.

The resin may include epoxy, polyimide, liquid crystal polymer (LCP), or the like, or mixtures thereof, but is not limited thereto.

The body 100 may include a core 110 penetrating through the support member 200 and the coil 300. The core 110 may be formed by filling a through-hole of the support member200 with the magnetic composite sheet, but is not limited thereto.

Referring to FIGS. 3 and 4, the body 100 may include the core 110 penetrating through the support member 200 and the coil 300. The core 110 may be disposed in a central region of the innermost turn of the coil 300, that is, in a winding central region of the coil 300.

Referring to FIGS. 2 through 4, the core 110 may be formed by filling a through-hole H penetrating through the center of the coil 300 and the center of the support member 200 with the magnetic composite sheet containing the magnetic material, but is not limited thereto. In a case of forming the body 100 by mold pressing or the like, the core 110 may be formed by filling the through-hole H penetrating through the center of the coil 300 and the center of the support member 200 with a magnetic material and a resin.

The support member 200 may be disposed inside the body 100 and may have one surface and another surface opposing each other, and a side surface connecting the one surface and the other surface to each other. The support member 200 may support the coil 300. Further, a central portion of the support member 200 may be removed by trimming to form the through-hole H, and the core 110 may be disposed in the through-hole H. Here, the through-hole H formed in the support member 200 may be formed in a shape corresponding to a shape of the innermost turn of the coil 300.

The support member 200 may be formed of an insulating material including a thermosetting insulating resin such as an epoxy resin, a thermoplastic insulating resin such as a polyimide resin, or a photosensitive insulating resin or be formed of an insulating material having a reinforcing material such as a glass fiber or an inorganic filler impregnated in such an insulating resin. As an example, the support member 200 may be formed of an insulating material such as prepreg, an Ajinomoto Build-up Film (ABF), FR-4, a Bismaleimide Triazine (BT) resin, or a photoimagable dielectric (PID), but is not limited thereto.

As a material of the inorganic filler, one or more materials selected from the group consisting of silica (SiO₂), alumina (Al₂O₃), silicon carbide (SiC), barium sulfate (BaSO₄), talc, clay, mica powder, aluminum hydroxide (Al(OH)₃), magnesium hydroxide (Mg(OH)₂), calcium carbonate (CaCO₃), magnesium carbonate (MgCO₃), magnesium oxide (MgO), boron nitride (BN), aluminum borate (AlBO₃), barium titanate (BaTiO₃), and calcium zirconate (CaZrO₃) may be used.

In a case where the support member 200 is formed of the insulating material including the reinforcing material, the support member 200 may provide more excellent rigidity. In a case where the support member 200 is formed of an insulating material that does not include a glass fiber, the support member 200 may be advantageous in decreasing a thickness of the coil component 1000 according to the present exemplary embodiment. In addition, a volume occupied by the coil 300 and/or the magnetic metal powder may be increased on the basis of the body 100 having the same size, such that component characteristics may be improved. In a case where the support member 200 is formed of the insulating material including the photosensitive insulating resin, the number of processes for forming the coil 300 may be decreased, which may be advantageous in reducing a production cost and may be advantageous in forming a fine via 320.

A thickness of the support member 200 may be, for example, 10 μm or more and 50 μm or less, but is not limited thereto.

The coil 300 may be disposed inside the body 100, and may implement characteristics of the coil component 1000. For example, in a case where the coil component 1000 according to the present exemplary embodiment is utilized as a power inductor, the coil 300 may serve to store an electric field as a magnetic field to maintain an output voltage, resulting in stabilization of power of an electronic device.

The coil component 1000 according to the present exemplary embodiment may include the coil 300 supported by the support member 200 inside the body 100. The coil 300 may have at least one turn around the core 110.

Referring to FIGS. 1 through 4, the coil 300 of the present exemplary embodiment may include first and second coil portions 311 and 312, and the first and second lead portions 331 and 332, and may further include a via 320 penetrating through the support member 200 and connecting the first and second coil portions 311 and 312 to each other.

Specifically, the first coil portion 311 and the first lead portion 331 extending from the outermost turn of the first coil portion 311 may be disposed on one surface of the support member 200 that faces the first surface 101 of the body 100. Further, the second coil portion 312 and the second lead portion 332 extending from the outermost turn of the second coil portion 312 may be disposed on the other surface of the support member 200 that faces the second surface 102 of the body 100.

Referring to FIGS. 2 through 4, each of the first coil portion 311 and the second coil portion 312 may have at least one turn around the core 110. Each of the first coil portion 311 and the second coil portion 312 may have a planar spiral shape.

The first coil portion 311 may be disposed on one surface of the support member 200 and have at least one turn around the core 110 as an axis. The second coil portion 312 may be disposed on the other surface of the support member 200 and have at least one turn around the core 110 as an axis.

Referring to FIG. 4, the coil 300 may include the via 320 connecting the first coil portion 311 disposed on one surface of the support member 200 and the second coil portion 312 disposed on the other surface of the support member 200 to each other. The via 320 may electrically connect the first and second coil portions 311 and 312 on both surfaces of the support member 200.

The via 320 may connect an end of the innermost turn of the first coil portion 311 and an end of the innermost turn of the second coil portion 312 to each other. Further, the via 320 may penetrate through the support member 200, but is not limited thereto.

A diameter of the via 320 according to the present exemplary embodiment may be smaller than a line width of each of the coil portions 311 and 312, and only one via 320 may be disposed inside the support member 200, the diameter of the via 320 and the number of vias 320 are not limited thereto.

Referring to FIGS. 1, 2, 5, and 6, the coil 300 may include the first and second lead portions 331 and 332 extending from the outermost turns of the coil portions 311 and 312, respectively, and bent toward the first surface 101 of the body 100.

Specifically, the first lead portion 331 disposed on one surface of the support member 200 may extend from an end of the outermost turn of the first coil portion 311, be bent toward the first surface 101 of the body 100, and be connected to the first external electrode 410. Further, the second lead portion 332 disposed on the other surface of the support member 200 may extend from an end of the outermost turn of the second coil portion 312, be bent toward the first surface 101 of the body 100, and be connected to the second external electrode 420. Here, portions of the first and second lead portions 331 and 332 extending between the respective outermost turns of the first and second coil portions 311 and 312 and respective bent portions thereof may be substantially parallel to the first surface 101 of the body 100. On the other hand, portions of the first and second lead portions 331 and 332 extending between respective bent portions thereof and the first and second external electrodes 410 and 420 may be substantially perpendicular to the first surface 101 of the body 100.

One or ordinary skill in the art would understand that the expression “substantially parallel” or “substantially perpendicular” may mean not only being exactly parallel) (0°) or perpendicular (90°) but also being close to parallel or perpendicular including process errors, positional deviations, and/or measurement errors that may occur in a manufacturing process, and the range thereof may be widely accepted in the art. In one or more aspects, the terms “about,” “substantially,” and “approximately” may provide an industry-accepted tolerance for their corresponding terms and/or relativity between items, such as a tolerance of from less than one percent to 10 percent of the actual value stated, and other suitable tolerances.

Referring to FIGS. 1 and 2, the first lead portion 331 and the second lead portion 332 may extend in the same direction.

Specifically, the first and second lead portions 331 and 332 may extend toward the third surface 103 of the body 100 in the second direction W and be bent toward the first surface 101 Of the body 100 in the first direction T.

Here, positions at which the first and second lead portions 331 and 332 are bent may be closer to the third surface 103 of the body 100 than to the fourth surface 104 of the body 100. That is, the first and second lead portions 331 and 332 extend toward the third surface 103 of the body 100 and are bent toward the first surface 101 of the body 100, and thus, the positions at which the first and second lead portions 331 and 332 are bent may be disposed in such a way as to be biased toward the third surface 103 of the body 100.

Meanwhile, referring to FIG. 6, at least a portion of the side surface of the support member 200 may be covered by the second lead portion 332.

That is, the second lead portion 332 is continuously disposed along the other surface and the side surface of the support member 200 and is connected to the second external electrode 420, and thus, at least a portion of the second lead portion 332 may be disposed on the side surface of the support member 200. In addition, the insulating film IF may be interposed between the side surface of the support member 200 and the second lead portion 332.

With such a structure, the second lead portion 332 on the other surface of the support member 200 may be directly connected to the second external electrode 420 disposed on the first surface 101 of the body 100 without separate via hole formation in a region of the support member 200 where the second lead portion 332 is disposed.

Therefore, the coil component 1000 according to the present exemplary embodiment may have an electrode structure implemented through a simpler process.

Referring to FIG. 2, for example, in a case where a signal is input to the first external electrode 410, the input signal may be output to the second external electrode 420 through the first lead portion 331, the first coil portion 311, the via 320, and the second coil portion 312, the second lead portion 332 in this order.

In such a manner, the coil 300 may function as a single coil as a whole between the first and second external electrodes 410 and 420.

At least one of the first and second coil portions 311 and 312, the via 320, and the first and second lead portions 331 and 332 may include at least one conductive layer.

For example, when the first coil portion 311, the via 320, and the first lead portion 331 are formed by plating on one surface of the support member 200, the first coil portion 311, the via 320, and the first lead portion 331 may respectively include a seed layer and an electroplating layer. Here, the electroplating layer may have a single-layer structure or have a multilayer structure. The electroplating layer having the multilayer structure may be formed in a conformal film structure in which another electroplating layer is formed along a surface of any one electroplating layer or be formed in a shape in which another electroplating layer is stacked on only one surface of any one electroplating layer. The seed layer may be formed by a vapor deposition method or the like such as an electroless plating method or a sputtering method. The seed layers of the first coil portion 311, the via 320, and the first lead portion 331 may be formed integrally with each other, so that a boundary therebetween is not formed. However, the seed layers of the first coil portion 311, the via 320, and the first lead portion 331 are not limited thereto. The electroplating layers of the first coil portion 311, the via 320, and the first lead portion 331 may be formed integrally with each other, so that a boundary therebetween is not formed. However, the electroplating layers of the first coil portion 311, the via 320, and the first lead portion 331 are not limited thereto.

Each of the first coil portion, 311, the via 320, and the first lead portion 331 may be formed of a conductive material such as copper (Cu), aluminum (Al), silver (Ag), tin (Sn), gold (Au), nickel (Ni), lead (Pb), titanium (Ti), chromium (Cr) or alloys thereof, but is not limited thereto.

In the coil component 1000 according to the present exemplary embodiment, the first and second lead portions 331 and 332 are formed on the support member 200 by plating in a direction parallel to the second direction W and are then bent downward in the first direction T. Therefore, metal components may be partially stretched and rounded in bent regions of the first and second lead portions 331 and 332, but the scope of the present disclosure is not limited thereto.

In addition, as the lead portions 331 and 332 are bent after the insulating film IF is disposed on the first and second lead portions 331 and 332, the insulating film IF may also be disposed in regions of the first and second lead portions 331 and 332 that are substantially parallel to the first direction T.

Referring to FIGS. 3 through 6, the coil component 1000 according to the present embodiment may further include the insulating film IF. The insulating film IF may be a component that may increase insulation reliability of the coil component 1000 by preventing a current leakage between the coil 300 and the body 100.

The insulating film IF may be disposed between the

coil 300 and the body 100 and cover the coil 300. Specifically, the insulating film IF may be disposed along the surfaces of the first and second coil portions 311 and 312 and the first and second lead portions 331 and 332 disposed on the support member 200.

The insulating film IF may insulate between adjacent turns of the first coil portion 311, between adjacent turns of the second coil portion 312, between the outermost turn of the first coil portion 311 and the first lead portion 331, and between the outermost turn of the second coil portion 312 and the second lead portion 332.

Referring to FIGS. 5 and 6, the insulating film IF may be disposed to cover the regions of the first and second lead portions 331 and 332 bent toward the first surface 101 of the body 100. That is, since the first and second lead portions 331 and 332 are bent toward the first surface 101 of the body 100 after the insulating film IF is disposed on the first and second lead portions 331 and 332, the regions of the first and second lead portions 331 and 332 that are parallel to the first direction T may also be covered by the insulating film IF.

With such a structure, in the coil component 1000 according to the present exemplary embodiment, the external electrodes 410 and 420 disposed on the lower surface of the body 100 and the coil 300 may be connected to each other inside the body 100, thereby minimizing minimize a loss of an effective volume of the body 100. In addition, the insulating film IF may also be disposed on the first and second lead portions 331 and 332 that serve as connection passages between the coil 300 and the external electrodes 410 and 420, thereby improving the insulation reliability.

Meanwhile, referring to FIG. 6, the insulating film IF may be disposed after the coil 300 is disposed on the support member 200 and an end portion of the support member 200 is partially removed for bending the second lead portion 332. In this case, the insulating film IF may be interposed between the side surface of the support member 200 and the bent second lead portion 332, but is not limited thereto.

The insulating film IF according to the present exemplary embodiment may include a known insulating material such as parylene, but is not limited thereto. As another example, the insulating film IF may include an insulating material such as an epoxy resin rather than parylene. The insulating film IF may be formed by a vapor deposition method, but is not limited thereto. As another example, the insulating film IF may be formed by stacking and then curing an insulation film on the support member 200 on which the coil 300 is disposed or may be formed by applying and then curing an insulation paste onto both surfaces of the support member 200 on which the coil 300 is disposed.

Meanwhile, for the reason described above, the insulating film IF may be omitted in the present exemplary embodiment. That is, when the body 100 has a sufficient electrical resistance at a designed operating current and voltage of the coil component 1000 according to the present exemplary embodiment, the insulating film IF may be omitted in the present exemplary embodiment.

The external electrodes 410 and 420 may be connected to a circuit through a coupling member such as solder when the coil component 1000 is mounted on a circuit board.

Referring to FIGS. 1 through 3, 5, and 6, the external electrodes 410 and 420 may be disposed on the first surface 101 of the body 100 and connected to the first and second lead portions 331 and 332, respectively.

Specifically, the first and second external electrodes 410 and 420 may be disposed to be spaced apart from each other on the first surface 101 of the body 100, the first external electrode 410 may be connected to the first lead portion 331, and the second external electrode 420 may be connected to the second lead portion 332.

The first and second external electrodes 410 and 420 according to the present exemplary embodiment may be disposed only on the first surface 101 of the body 100 and may not be disposed on the remaining surfaces, but are not limited thereto.

When the first and second external electrodes 410 and 420 are disposed only on the first surface 101 of the body 100 as in the present exemplary embodiment, the lower electrode structure is implemented, so that a possibility of a short circuit with adjacent components may be reduced when mounting the coil component 1000 on a circuit board, which is advantageous for integration, and the effective volume of the body 100 may be secured as much as possible within a limited size of the coil component 1000.

The first and second external electrodes 410 and 420 may be formed by a vapor deposition method such as sputtering and/or a plating method, but are not limited thereto.

The first and second external electrodes 410 and 420 may be formed of a conductive material such as copper (Cu), aluminum (Al), silver (Ag), tin (Sn), gold (Au), nickel (Ni), lead (Pb), chromium (Cr), titanium (Ti), or alloys thereof, but are not limited thereto.

The first and second external electrodes 410 and 420 may be formed in a single layer structure or a multilayer structure. As an example, the first and second external electrodes 410 and 420 may respectively include a first conductive layer including copper (Cu), a second conductive layer disposed on the first conductive layer and including nickel (Ni), and a third conductive layer disposed on the second conductive layer and including tin (Sn). At least one of the second conductive layer or the third conductive layer may be formed to cover the first conductive layer, but the scope of the present disclosure is not limited thereto. The first conductive layer may be a plating layer or be a conductive resin layer formed by applying and then curing a conductive resin including conductive powders including at least one copper (Cu) and silver (Ag) and a resin. The second and third conductive layers may be plating layers, but the scope of the present disclosure is not limited thereto.

Referring to FIGS. 3 through 6, the coil component 1000 according to the present exemplary embodiment may further include the insulating layer 500 covering at least a portion of the surface of the body 100 and exposes the external electrodes 410 and 420.

The insulating layer 500 may be disposed in a region other than a region where the external electrodes 410 and 420 are disposed, among the first to sixth surfaces 101 to 106 of the body 100.

At least portions of the insulating layer 500 disposed on the first to sixth surfaces 101 to 106 of the body 100 may be formed integrally with each other in the same process in such a way that boundaries therebetween are not formed, but the scope of the present disclosure is not limited thereto.

The insulating layer 500 may be formed by a method such as printing, vapor deposition, spray coating, or film lamination, but is not limited thereto.

The insulating layer 500 may include a thermoplastic resin such as polystyrenes, vinyl acetates, polyesters, polyethylenes, polypropylenes, polyamides, rubbers, or acryls, a thermosetting resin such as phenols, epoxies, urethanes, melamines, or alkyds, a photosensitive resin, parylene, SiOₓ, or SiNₓ. The insulating layer 500 may further include an insulating filler such as an inorganic filler, but is not limited thereto.

### Second Exemplary Embodiment

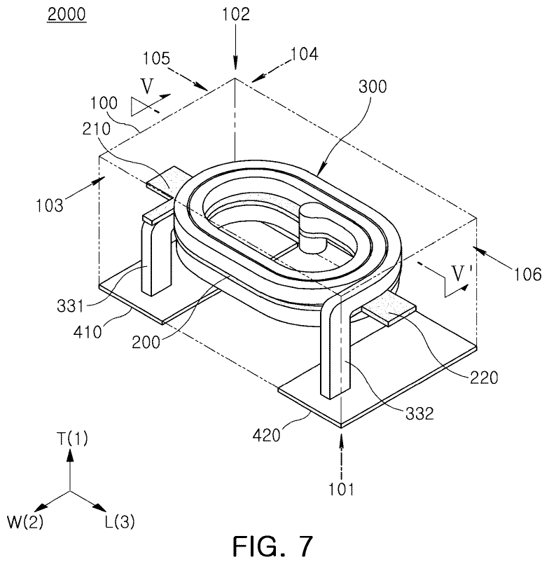

FIG. 7 is a schematic perspective view illustrating

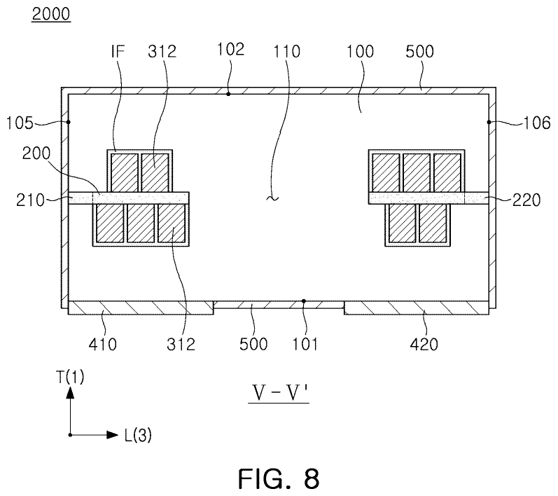

a coil component 2000 according to a second exemplary embodiment in the present disclosure. FIG. 8 is a cross- sectional view taken along line V-V′ of FIG. 7.

FIGS. 7 and 8 are different from FIGS. 1 and 3 in that a support member 200 further includes protrusions 210 and 220.

Therefore, in describing the present exemplary embodiment, only a shape of the support member 200 and the protrusions 210 and 220, which are different from those in the first exemplary embodiment of the present disclosure, will be described. The description in the first exemplary embodiment in the present disclosure may be applied to other components of the present exemplary embodiment as it is.

Referring to FIGS. 7 and 8, the support member 200 according to the present exemplary embodiment may include the protrusions 210 and 220 protruding toward at least one of a fifth surface 105 or a sixth surface 106 of the body 100.

Specifically, the support member 200 according to the present exemplary embodiment may include the first protrusion 210 protruding toward the fifth surface 105 of the body 100, and the second protrusion 220 protruding toward the sixth surface 106 of the body 100. However, the scope of the present disclosure is not limited thereto, and only one of the first protrusion 210 and the second protrusion 220 may be formed on the support member 200.

Lead portions 331 and 332 may not be disposed on the protrusions 210 and 220, and the protrusions 210 and 220 may correspond to regions left without being removed when performing trimming to remove the remaining portion after a coil 300 is disposed on the support member 200.

Referring to FIGS. 7 and 8, the protrusions 210 and 220 may extend in the third direction L and be exposed to at least one of the fifth surface 105 or the sixth surface 106 of the body 100.

Specifically, the first protrusion 210 according to the present exemplary embodiment may extend in the third direction L and be exposed to the fifth surface 105 of the body 100, and the second protrusion 220 may extend in the third direction L and be exposed to the sixth surface 106 of the body 100. However, the scope of the present disclosure is not limited thereto, and only one of the first protrusion 210 and the second protrusion 220 of the support member 200 may be exposed to the surface of the body 100.

Referring to FIG. 8, the protrusions 210 and 220 exposed to the surface of the body 100 may be covered by an insulating layer 500 disposed on at least one of the fifth surface 105 or the sixth surface 106 of the body 100.

Specifically, the first protrusion 210 according to the present exemplary embodiment may be at least partially covered by the insulating layer 500 disposed on the fifth surface 105 of the body 100, and the second protrusion 220 may be at least partially covered by the insulating layer 500 disposed on the sixth surface 106 of body 100. However, the scope of the present disclosure is not limited to this, and only one of the first protrusion 210 and the second protrusion 220 may be covered by the insulating layer 500.

As the coil component 2000 according to the present exemplary embodiment includes the protrusions 210 and 220, an anchoring effect may occur between the protrusions 210 and 220 and the body 100, so that a support force of the support member 200 supporting the coil 300 may be increased, and defects in which the coil 300 is misaligned during a process of forming the body 100 may be reduced.

Further, process efficiency may also be improved by partially leaving portions where the support members 200 are connected to each other as the protrusions 210 and 220 in a process of trimming the support member 200 to the shape of the coil 300 in a coil bar state in which a plurality of coils 300 are connected to each other in a lattice shape on the support member 200 having the shape of a substrate.

### Coil Component Manufacturing Process

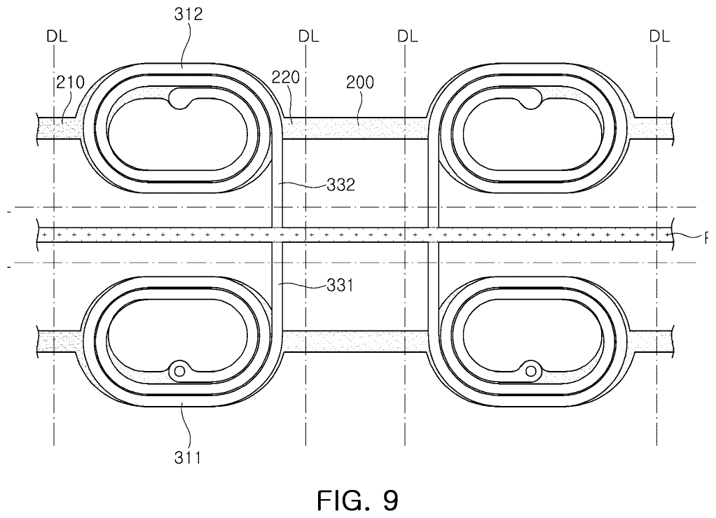

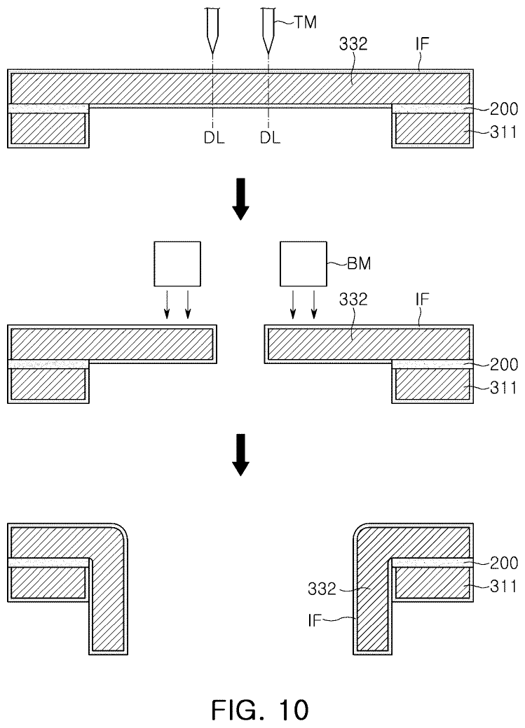

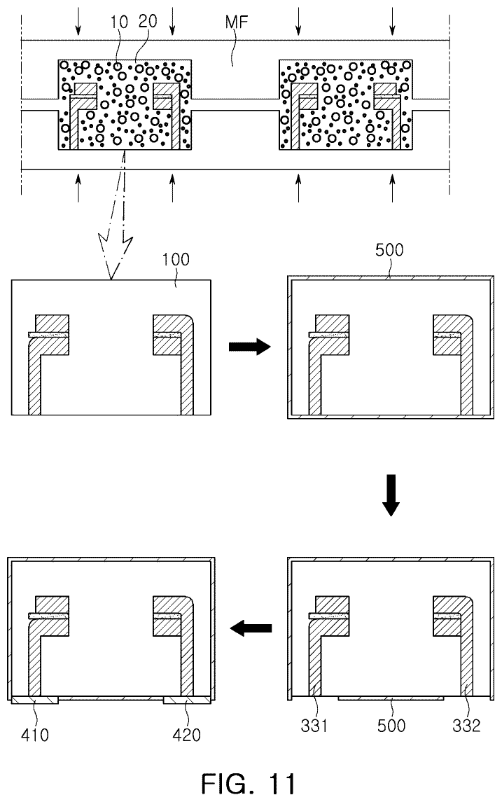

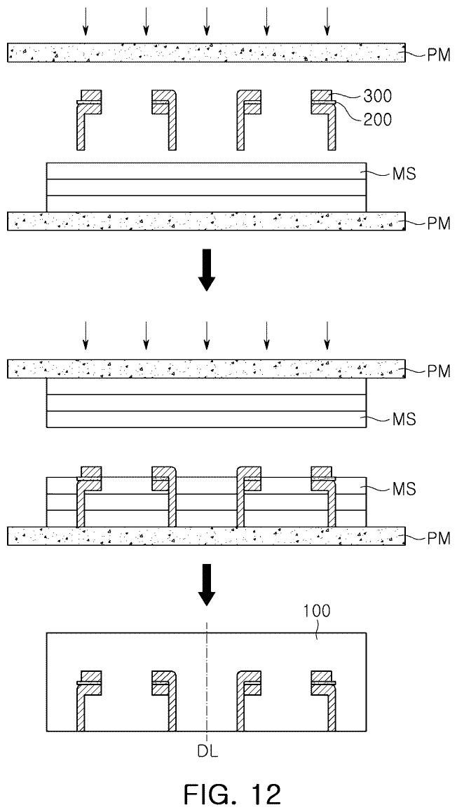

FIG. 9 is a schematic view illustrating the coil bar state before the plurality of coils 300 are individualized. FIG. 10 is a schematic view illustrating a process of bending the first and second lead portions 331 and 332 downward. FIG. 11 is a schematic view illustrating a process of forming the body 100 using a mold MF. FIG. 12 is a schematic view illustrating a process of forming the body 100 by stacking magnetic sheets (MS).

FIG. 9 is a schematic view illustrating the coil bar state before the plurality of coils are individualized.

Referring to FIG. 9, a plurality of coil portions 311 and 312 may be patterned on the support member 200 having the shape of a substrate by using a plating solution supplied from a plating bar (PE). At this time, a region connected to the plating bar PE may be cut along a dicing line DL and then bent to be used as the lead portion 331 or 332.

Further, the protrusions 210 and 220 having an anchoring effect may be formed on the support member 200 as in the second exemplary embodiment by leaving portions of the support member 200 between the plurality of coils 300.

Meanwhile, in a case where the protrusions 210 and 220 are trimmed to the shape of the coil 300, the structure of the coil component 1000 according to the first exemplary embodiment may be implemented. In this case, the magnetic material of the body 100 may be disposed in regions where the protrusions 210 and 220 are removed, thereby securing the effective volume.

FIG. 10 is a schematic view illustrating a process of bending the first and second lead portions 331 and 332 downward.

Referring to FIG. 10, the support member 200 may be partially removed by a length of the first and second lead portions 331 and 332 after forming the insulating film IF on the coil 300 in which the first and second lead portions 331 and 332 are connected to each other as illustrated in FIG. 9. Next, the coil 300 may be cut along the dicing line DL using a trimming member TM, leaving a predetermined length of the first and second lead portions 331 and 332 of the coil 300 for bending.

For example, in a case of the coil component 1000 having a length of 1.0 mm, a width of 0.7 mm, and a thickness of 0.65 mm, it may be preferable that a length of a bent region of the first lead portion 331 is 0.3125 mm, and a length of a bent region of the second lead portion 332 is 0.2775 mm, but the lengths of the bent regions are not limited thereto.

Next, a pressure may be applied downward to the cut ends of the first and second lead portions 331 and 332 by using a bending member BM.

As a result, the first and second lead portions 331 and 332 may be bent downward, and the second lead portion 332 disposed on an upper surface of the support member 200 may cover a portion of the side surface of the support member 200.

Meanwhile, the insulating film between the second lead portion 332 and the side surface of the support member 200 may be formed as one layer or two layers depending on an arrangement order of the insulating film IF. For example, in a case of removing a portion of the support member 200 below the second lead portion 332, forming the insulating film IF, and then bending the second lead portion 332 downward, the insulating film between the second lead portion 332 and the side surface of the support member 200 may be formed as two layers, but is not limited thereto, and the insulating film IF may be integrated in such a way that a boundary therebetween is not formed. Further, in a case of forming the insulating film IF on the surface of the second lead portion 332, removing a portion of the support member 200 below the second lead portion 332, and then bending the second lead portion 332 downward, the insulating film between the second lead portion 332 and the side surface of the support member 200 may be formed as one layer.

FIG. 11 is a schematic view illustrating the process of forming the body 100 using the mold MF.

Referring to FIG. 11, the body 100 may be formed by putting a coil bar in the mold MF, filling the mold MF with a composite material containing magnetic powder 10 and a resin 20, and then compressing the mold MF. The compression may be performed under a high-temperature and high-pressure condition, but is not limited thereto.

Next, the insulating layer 500 may be disposed on the surface of the body 100 formed as an individual component. The insulating layer 500 may be formed by a method such as printing, vapor deposition, spray coating, or film lamination, but is not limited thereto.

Next, the insulating layer 500 may be partially removed using a laser to expose the first and second lead portions 331 and 332 in the regions where the external electrodes 410 and 420 are to be disposed on the lower surface of the body 100.

Next, the external electrodes 410 and 420 may be disposed in the regions where the insulating layer 500 has been removed by plating, and the first and second external electrodes 410 and 420 may be formed to have a single-layer structure or a multilayer structure.

FIG. 12 is a schematic view illustrating the process of forming the body 100 by stacking the magnetic sheets (MS) unlike FIG. 11. A process of forming the support member 200 and the coil 300 is the same as described above.

Referring to FIG. 12, first, a required number of magnetic sheets MS may be stacked on a compression member PM, and the coil 300 disposed on the support member 200 may be disposed on the stacked magnetic sheets MS. At this time, it is preferable to arrange the magnetic sheets MS in such a way that a total thickness of the magnetic sheets MS does not exceed ½ of the thickness of the body 100 to prevent deformation of the coil 300 during compression, but is not limited thereto.

Next, the remaining magnetic sheet MS may be stacked on an upper side of the coil 300 disposed on the support member 200 by using the compression member PM.

Next, the body 100 formed through compression and curing may be diced along the dicing line DL by using a dicing blade or a laser, thereby forming the body 100 as an individual component.

The completed coil component 1000 may be obtained by disposing the insulating layer 500 and the external electrodes 410 and 420 as described above in FIG. 11 after the dicing.

As set forth above, according to the exemplary embodiments in the present disclosure, the external electrodes are disposed only on the lower surface of the coil component, thereby increasing the effective volume as compared to the coil component of the same size and improving the inductance characteristic.

According to the exemplary embodiments in the present disclosure, the plating quality and insulation reliability of the lead portion may be improved by implementing the coil covered with the insulating film and led out from the lower surface of the body and then forming the body.

While example embodiments have been shown and described above, it will be apparent to those skilled in the art that modifications and variations could be made without departing from the scope of the present invention as defined by the appended claims.

What is claimed is:

1. A coil component comprising:
a body having a first surface and a second surface opposing each other in a first direction, and a third surface and a fourth surface opposing each other in a second direction perpendicular to the first direction;
a support member disposed inside the body and having one surface and another surface opposing each other, and a side surface connecting the one surface and the other surface to each other;
a coil disposed on the support member and including coil portions respectively having at least one turn and lead portions extending from respective outermost turns of the coil portions and bent toward the first surface of the body; and
external electrodes disposed on the first surface of the body and connected to the respective lead portions.

2. The coil component according to claim 1, wherein the coil portions include a first coil portion disposed on the one surface of the support member and a second coil portion disposed on the other surface of the support member,
the lead portions include a first lead portion extending from the outermost turn of the first coil portion and a second lead portion extending from the outermost turn of the second coil portion, and
the first and second lead portions extend in the same direction.

3. The coil component according to claim 2, wherein the first and second lead portions extend toward the third surface in the second direction, and are bent toward the first surface in the first direction.

4. The coil component according to claim 1, wherein positions where the lead portions are bent are closer to the third surface than to the fourth surface.

5. The coil component according to claim 2, further comprising an insulating film disposed between the coil and the body and covering the coil.

6. The coil component according to claim 5, wherein the insulating film covers regions of the lead portions that are bent toward the first surface.

7. The coil component according to claim 5, wherein at least a portion of the side surface of the support member is covered by the second lead portion.

8. The coil component according to claim 7, wherein the insulating film is interposed between the side surface of the support member and the second lead portion.

9. The coil component according to claim 1, wherein the body further has a fifth surface and a sixth surface opposing each other in a third direction, perpendicular to the first direction and the second direction, and
the support member includes a protrusion protruding toward at least one of the fifth surface or the sixth surface.

10. The coil component according to claim 9, wherein the protrusion extends in the third direction and is exposed to at least one of the fifth surface or the sixth surface.

11. The coil component according to claim 10, further comprising an insulating layer covering at least a portion of a surface of the body and exposing the external electrodes.

12. The coil component according to claim 11, wherein the insulating layer is disposed on at least one of the fifth surface or the sixth surface and covers the protrusion.

13. The coil component according to claim 2, wherein the coil further includes a via penetrating the support member and connecting the first and second coil portions to each other.

14. The coil component according to claim 2, wherein the external electrodes include a first external electrode connected to the first lead portion and a second external electrode connected to the second lead portion, and
the second coil portion disposed on the other surface of the support member is connected to the second external electrode through the second lead portion continuously disposed on the other surface and the side surface of the support member.

15. The coil component according to claim 14, wherein the first and second external electrodes are disposed only on the first surface.

16. A coil component comprising:
a body;
a support member embedded in the body;
a coil including a first coil portion disposed on one surface of the support member and a second coil portion disposed on another surface of the support member opposing the one surface;
first and second lead portions extending toward a same side surface of the body from respective outermost turns of the first and second coil portions; and
first and second external electrodes disposed on the body and connected to the first and second lead portions, respectively,
wherein the first and second lead portions have first and second bent portions in the body and further extend to be connected to the first and second external electrodes, respectively.

17. The coil component according to claim 16, wherein the first and second external electrodes are disposed on a first surface of the body and spaced apart from each other.

18. The coil component according to claim 17, wherein portions of the first and second lead portions extending between the respective outermost turns of the first and second coil portions and respective bent portions thereof are substantially parallel to the first surface of the body.

19. The coil component according to claim 17, wherein portions of the first and second lead portions extending between respective bent portions thereof and the first and second external electrodes are substantially perpendicular to the first surface of the body.
